(19) United States
(12) Patent Application Publication
(10) Pub. No.: US 2023/0003405 A1
(43) Pub. Date: Jan. 5, 2023

(54) Temperature Control Method, System and Temperature Controller

(71) Applicant: ARIZE CORPORATION, Anaheim, CA (US)

(72) Inventors: Xingzai CHEN, Shenzhen (CN); Yonghui YAN, Shenzhen (CN)

(21) Appl. No.: 17/732,406

(22) Filed: Apr. 28, 2022

(30) Foreign Application Priority Data
Jun. 30, 2021 (CN) 202110744210.1

(51) Int. Cl. F24F 11/46; G05B 19/042

(52) U.S. Cl. CPC F24F 11/46; G05B 19/042; F24F 2110/10

(57) ABSTRACT

Embodiments of the application disclose a temperature control method, system and a temperature controller. The method includes: obtaining a target temperature value set by a user; obtaining a current energy-saving level, the current energy-saving level being used to limit an adjustment speed at which a HVAC system controls a temperature change; determining a target difference between indoor and outdoor temperatures based on a current indoor temperature value and a current outdoor temperature value; determining a target adjustment speed corresponding to the target difference between indoor and outdoor temperatures; determining a target operating mode based on a relationship between the current energy-saving level and the target adjustment speed; and controlling the HVAC system to perform a temperature adjustment operation in the target operating mode. The method can improve the user's comfort experience and effectively reduce energy consumption.

### REFERENCE TO RELATED APPLICATION

This is a non-provisional application which claims priority to a Chinese patent application having an application number of CN202110744210.1, and a filing date of Jun. 30, 2021, the entire contents of which is hereby incorporated by reference.

### TECHNICAL FIELD

The application relates to the field of temperature adjustment technologies, and in particular, to a temperature control method, system and a temperature controller.

### BACKGROUND

A heating, ventilation, air-conditioning and cooling (HVAC) system is a system for controlling temperature, humidity, air cleanliness and air circulation.

A temperature controller is usually used to control start and shutdown of devices of an HVAC system based on a deviation relationship between a temperature value detected indoors and a set temperature, to perform cooling, heating or ventilating, and to adjust the indoor temperature. However, changes of indoor temperature are often affected by multiple factors. This type of temperature control solution has greater limitations and sometimes does not improve a user's comfort experience, but causes relatively great energy consumption.

### SUMMARY

This application provides a temperature control method, system and a temperature controller, which can solve the problems of low comfort and unnecessary energy consumption occurring when devices of an HVAC system are controlled based on a deviation relationship between a temperature value detected indoors and a set temperature.

According to an aspect, the application provides a temperature control method applied to a temperature controller, comprising:

obtaining a target temperature value set by a user;

obtaining a current energy-saving level, the current energy-saving level being used to limit an adjustment speed at which an HVAC system controls a temperature change;

determining a target difference between indoor and outdoor temperatures based on a current indoor temperature value and a current outdoor temperature value;

determining a target adjustment speed corresponding to the target difference between indoor and outdoor temperatures based on a corresponding relationship between an indoor and outdoor temperature difference of a current room and the adjustment speed at which the HVAC system controls a temperature change;

determining a target operating mode based on a relationship between the current energy-saving level and the target adjustment speed, the target operating mode including at least one of a temperature adjustment level and temperature adjustment duration; and

controlling the HVAC system to perform a temperature adjustment operation in the target operating mode.

Optionally, in a cooling scenario, the target adjustment speed corresponding to the target difference between indoor and outdoor temperatures is duration for natural temperature rise by one unit temperature and duration for cooling by one unit temperature by the HVAC system for the current room under the target difference between indoor and outdoor temperatures; and

the determining a target operating mode based on a relationship between the current energy-saving level and the target adjustment speed comprises:

based on that an adjustment speed corresponding to the current energy-saving level is a first speed, the first speed comprising upper limit duration for cooling by one unit temperature and lower limit duration for natural temperature rise by one unit temperature, and under a condition that the duration for cooling by one unit temperature is greater than the upper limit duration, determining that the temperature adjustment level is a second cooling level; and

under a condition that the duration for cooling by one unit temperature is less than the upper limit duration, determining that the temperature adjustment level is a first cooling level.

Optionally, the method further comprises:

under a condition that the duration for natural temperature rise by one unit temperature is less than the lower limit duration, extending the temperature adjustment duration in the target operating mode by preset duration; and

under a condition that the duration for natural temperature rise by one unit temperature is greater than the lower limit duration, shortening the temperature adjustment duration in the target operating mode by preset duration.

Optionally, in a heating scenario, the target adjustment speed corresponding to the target difference between indoor and outdoor temperatures is duration for heating by one unit temperature by the HVAC system and duration for natural temperature drop by one unit temperature for the current room under the target difference between indoor and outdoor temperatures; and

the determining a target operating mode based on a relationship between the current energy-saving level and the target adjustment speed comprises:

based on that an adjustment speed corresponding to the current energy-saving level is a second speed, the second speed comprising upper limit duration for heating by one unit temperature and lower limit duration for natural temperature drop by one unit temperature, and under a condition that the duration for heating by one unit temperature is greater than the upper limit duration, determining that the temperature adjustment level is a second heating level; and

under a condition that the duration for heating by one unit temperature is less than the upper limit duration, determining that the temperature adjustment level is a first heating level.

Optionally, the method further comprises:

under a condition that the duration for natural temperature drop by one unit temperature is less than the lower limit duration, extending the temperature adjustment duration in the target operating mode by preset duration; and

under a condition that the duration for natural temperature drop by one unit temperature is greater than the lower limit duration, shortening the temperature adjustment duration in the target operating mode by preset duration.

Optionally, the method further comprises:

obtaining a mapping relationship between a preset temperature difference relational expression and an operating mode, the preset temperature difference relational expression including a magnitude relational expression among a preset indoor temperature value, a target temperature value, and an outdoor temperature value; and

determining a target operating mode corresponding to a temperature difference relational expression met by the current indoor temperature value, the current target temperature value, and the current outdoor temperature value based on the mapping relationship.

Optionally, the determining a target operating mode corresponding to a temperature difference relational expression met by the current indoor temperature value, the current target temperature value, and the current outdoor temperature value based on the mapping relationship comprises:

under a condition that a result of subtracting the target temperature value from the current indoor temperature value is greater than a first threshold, and a result of subtracting the current indoor temperature value from the current outdoor temperature value is greater than a second threshold, determining that the temperature adjustment level is a second cooling level; under a condition that a result of subtracting the target temperature value from the current indoor temperature value is greater than a third threshold, and a result of subtracting the current indoor temperature value from the current outdoor temperature value is less than or equal to the second threshold, determining that the temperature adjustment level is the second cooling level, the second threshold is greater than the third threshold, and the third threshold is greater than the first threshold; and under a condition that a result of subtracting the target temperature value from the current indoor temperature value is less than or equal to the third threshold, and a result of subtracting the current indoor temperature value from the current outdoor temperature value is less than or equal to the second threshold, determining that the temperature adjustment level is the first cooling level;

or,

under a condition that a result of subtracting the target temperature value from the current indoor temperature value is less than a fourth threshold, and a result of subtracting the current indoor temperature value from the current outdoor temperature value is greater than a fifth threshold, determining that the temperature adjustment level is a second heating level; under a condition that a result of subtracting the target temperature value from the current indoor temperature value is greater than a sixth threshold, and a result of subtracting the current indoor temperature value from the current outdoor temperature value is less than or equal to the fifth threshold, determining that the temperature adjustment level is the second heating level, the sixth threshold is less than the fourth threshold, and the fifth threshold is greater than the fourth threshold; and under a condition that a result of subtracting the target temperature value from the current indoor temperature value is less than the fourth threshold and greater than the sixth threshold, and a result of subtracting the current indoor temperature value from the current outdoor temperature value is less than or equal to the fifth threshold, determining that the temperature adjustment level is the first heating level.

According to another aspect, a temperature controller is provided, comprising a main control chip and a memory, wherein

a computer program is stored in the memory, and when the computer program is executed by a processor, the processor is enabled to perform any possible step according to the first aspect.

According to still another aspect, a temperature control system is provided, comprising an HVAC system, an outdoor sensor, and the temperature controller according to the foregoing aspect, wherein

the temperature controller is connected to the HVAC system through a control line;

the outdoor sensor is configured to acquire an outdoor temperature value and provide the outdoor temperature value to the temperature controller; and

the temperature controller is configured to perform steps of the method according to any one of the foregoing aspects and any possible implementation thereof.

According to yet another aspect, a computer storage medium is further provided, wherein the computer storage medium stores one or more instructions, and the one or more instructions are suitable for being loaded by a processor and performing steps of the method according to any one of the foregoing aspects and any possible implementation thereof.

According to still yet another aspect, a temperature controller is provided, comprising:

an obtaining module, configured to obtain a target temperature value set by a user;

the obtaining module, further configured to obtain a current energy-saving level, the current energy-saving level being used to limit an adjustment speed at which an HVAC system controls a temperature change; and

a processing module, configured to determine a target difference between indoor and outdoor temperatures based on a current indoor temperature value and a current outdoor temperature value;

the processing module, further configured to determine a target adjustment speed corresponding to the target difference between indoor and outdoor temperatures based on a corresponding relationship between an indoor and outdoor temperature difference of a current room and the adjustment speed at which the HVAC system controls a temperature change;

the processing module, further configured to determine a target operating mode based on a relationship between the current energy-saving level and the target adjustment speed, the target operating mode including at least one of a temperature adjustment level and temperature adjustment duration; and

the processing module, further configured to control the HVAC system to perform a temperature adjustment operation in the target operating mode.

The application provides a temperature control method applied to a temperature controller, including: obtaining a target temperature value set by a user; obtaining a current energy-saving level, the current energy-saving level being used to limit an adjustment speed at which an HVAC system controls a temperature change; determining a target difference between indoor and outdoor temperatures based on a current indoor temperature value and a current outdoor temperature value; determining a target adjustment speed corresponding to the target difference between indoor and outdoor temperatures based on a corresponding relationship between an indoor and outdoor temperature difference of a current room and the adjustment speed at which the HVAC system controls a temperature change; determining a target operating mode based on a relationship between the current energy-saving level and the target adjustment speed, the target operating mode including at least one of a temperature adjustment level and temperature adjustment duration; and controlling the HVAC system to perform a temperature adjustment operation in the target operating mode. The operation on the HVAC system is reasonably controlled by considering an influence of a difference between indoor and outdoor temperatures, so that the user's comfort experience can be improved. The adjustment speed of the HVAC system is controlled by using the energy-saving level, thereby effectively reducing energy consumption.

### BRIEF DESCRIPTION OF THE DRAWINGS

To explain the embodiments of the application or the technical solutions in the prior art more clearly, the following will briefly describe the accompanying drawings that need to be used in the description of the embodiments or the prior art. Obviously, the accompanying drawings in the following description show only some embodiments of the application, and a person of ordinary skill in the art can still derive other accompanying drawings from these accompanying drawings without creative efforts.

In the figures,

FIG. 1 is a schematic flowchart of a temperature control method according to an embodiment of the application;

FIG. 2 is a schematic application diagram of an ordinary temperature controller according to an embodiment of the application;

FIG. 3 is a schematic diagram of cooling temperature changes according to an embodiment of the application;

FIG. 4 is a schematic diagram of heating temperature changes according to an embodiment of the application;

FIG. 5 is a schematic flowchart of another temperature control method according to an embodiment of the application;

FIG. 6 is a schematic structural diagram of a temperature controller according to an embodiment of the application; and

FIG. 7 is a schematic structural diagram of a temperature control system according to an embodiment of the application.

### DETAILED DESCRIPTION OF THE PREFERRED EMBODIMENT

The following clearly and completely describes the technical solutions in the embodiments of the application with reference to accompanying drawings in the embodiments of the application. Clearly, the described embodiments are merely some rather than all of the embodiments of the application. Based on the embodiments of the application, all other embodiments obtained by a person of ordinary skill in the art without creative efforts shall fall within the protection scope of the application.

A temperature controller mentioned in embodiments of the application refers to a series of automatic control elements that generate some special effects and perform turn-on or turn-off actions based on temperature changes of an operating environment, also referred to as temperature control switch, temperature protector, temperature controlling device, referred to as temperature controller for short. Alternatively, the temperature protector transmits a temperature to the temperature temperature controlling device, and the temperature controlling device sends a switch command to control the operation of a device to achieve a desired temperature and energy-saving effect.

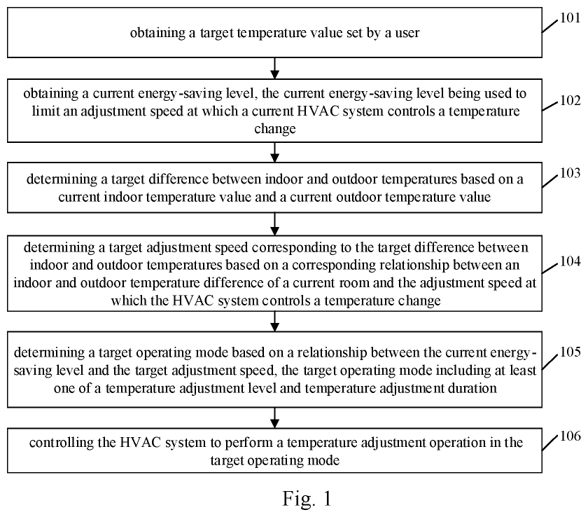

FIG. 1 is a flowchart of a temperature control method according to an embodiment of the application. The method shown in FIG. 1 is applied to a temperature controller. The method comprises the following steps.

101: obtaining a target temperature value set by a user.

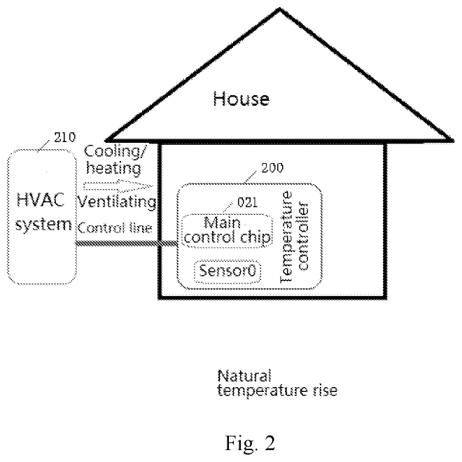

First, FIG. 2 is a schematic application diagram of an ordinary temperature controller according to an embodiment of the application. As shown in FIG. 2, the temperature controller 200 includes a main control chip 021, a temperature sensor Sensor0, and an input/output interactive interface (not marked in the figure). Generally, the temperature controller 200 is installed indoors and connected to an HAVC system 210 through a control line. By using a deviation obtained by comparing a measured temperature and a target temperature value set by the user, the temperature controller 200 outputs a control signal to control devices of the HAVC system 210 to perform heating, cooling, and ventilating. The HAVC system 210 may include devices installed indoors and outdoors, and the figure is only schematic.

In this embodiment of the application, the temperature controller is used to control the devices of the HAVC system, so as to control the indoor temperature. The target temperature value set by the user is a desired indoor temperature value.

102: obtaining a current energy-saving level, the current energy-saving level being used to limit an adjustment speed at which the current HVAC system controls a temperature change.

The forgoing energy-saving level may be set as required. The energy-saving level may limit an adjustment speed at which the HVAC system controls a temperature change. Optionally, different energy-saving levels may correspond to different adjustment speeds, which may include adjustment speeds for controlling temperature changes in cooling, heating and other modes.

103: determining a target difference between indoor and outdoor temperatures based on a current indoor temperature value and a current outdoor temperature value.

Specifically, the temperature controller may obtain the current indoor temperature value and the current outdoor temperature value, and calculate a target difference between indoor and outdoor temperatures.

The temperature controller may acquire the current indoor temperature value through the temperature sensor of the temperature controller, or optionally, the current indoor temperature value may be obtained by using an indoor temperature and humidity sensor.

Specifically, in a possible implementation solution, based on FIG. 2, in the embodiment of the application, an outdoor temperature sensor may be installed outside a house to acquire the outdoor temperature value; and the obtaining the current outdoor temperature value may include: obtaining the current outdoor temperature value acquired by an outdoor sensor module.

Optionally, the temperature controller may include a gateway module, and the current outdoor temperature value acquired by the outdoor sensor module may be obtained by using the gateway module.

Alternatively, the temperature controller may include a communication module, and the communication module connected to the Internet may obtain the current outdoor temperature value acquired by the outdoor sensor module and uploaded to the Internet.

Optionally, the outdoor sensor may be a wireless temperature sensor, the communication module may be a Wi-Fi wireless communication module, and the gateway module may be a wireless gateway module, which is not limited in the embodiment of the application.

In another possible implementation solution, a real-time outdoor temperature value under the current location may be obtained by a third party. In the application, no limitation is imposed on the obtaining of the outdoor temperature.

104: determining a target adjustment speed corresponding to the target difference between indoor and outdoor temperatures based on a corresponding relationship between an indoor and outdoor temperature difference of a current room and the adjustment speed at which the HVAC system controls a temperature change.

In this embodiment of the application, the temperature controller may record an adjustment speed at which the HVAC system controls a temperature change under a condition of different indoor and outdoor temperatures, and may record cooling and heating scenarios in a classified manner. The temperature controller may store the recorded adjustment speed at which the HVAC system controls a temperature change in the current room in different scenarios with a difference between indoor and outdoor temperatures.

Specifically, data such as time for starting each device in the HVAC system, indoor temperature, outdoor temperature, and target temperature of a current room, as well as data such as temperature data and duration for temperature recovery after shutdown of the device, may be continuously recorded, and then the adjustment speed is obtained based on enough data.

In an implementation, the adjustment speed of the HVAC system in different scenarios with a difference between indoor and outdoor temperatures for the current room may include: in a cooling scenario, duration for natural temperature rise by one unit temperature and duration for cooling by one unit temperature by the HVAC system for the current room under the target difference between indoor and outdoor temperatures; and in a heating scenario, duration for heating by one unit temperature by the HVAC system and duration for natural temperature drop by one unit temperature for the current room under the target difference between indoor and outdoor temperatures. Different options are available for the unit temperature. For example, if the unit temperature is 1° C., the adjustment speed may include duration for heating/cooling by 1° C., or duration for natural temperature rise/natural temperature drop by 1° C.

After the target adjustment speed corresponding to the target difference between indoor and outdoor temperatures is determined, a temperature control strategy may be adjusted based on the target adjustment speed.

105: determining a target operating mode based on a relationship between the current energy-saving level and the target adjustment speed, the target operating mode including at least one of a temperature adjustment level and temperature adjustment duration.

Specifically, in this embodiment of the application, adjustment speeds corresponding to different energy-saving levels of the HVAC system may be preset. After the current energy-saving level is determined, the target adjustment speed corresponding to the target difference between indoor and outdoor temperatures may be compared with the adjustment speed corresponding to the current energy-saving level to determine the current target operating mode that should be used. The operating mode may include a temperature adjustment level of the HVAC system, for example, intensity of cooling/heating, and may further include temperature adjustment duration, that is, cooling/heating duration may be extended or shortened.

106: controlling the HVAC system to perform a temperature adjustment operation in the target operating mode.

Specifically, first, when the current indoor temperature value is less than the target temperature value, the indoor temperature may be controlled to increase, and when the current indoor temperature value is greater than the target temperature value, the indoor temperature may be controlled to decrease, so that the current indoor temperature value reaches the target temperature value, which may be used as the temperature control premise in the embodiment of the application.

An algorithm model involved in the embodiments of the application may be obtained based on acquisition of indoor and outdoor temperature data, and then through statistical integration. Due to the different techniques for construction of various houses, heat insulation effects of the housing may be quite different. Therefore, actual acquired data may be used to implement a temperature control algorithm that is more fit for needs (current room).

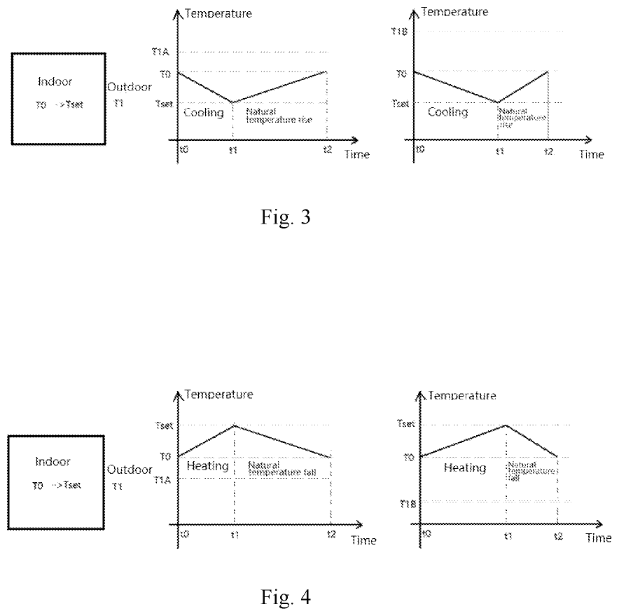

For example, FIG. 3 is a schematic diagram of cooling temperature changes according to an embodiment of the application. As shown in FIG. 3, when an outdoor temperature value T1A is relatively close to an indoor temperature value T0, duration required for cooling by 1° C. is relatively short, and duration required for natural temperature rise is relatively long, so that only first cooling level may be started, and the cooling duration is shortened; when an outdoor temperature value T1B is much greater than the indoor temperature value TO, duration required for cooling by 1° C. is relatively long, and duration required for natural temperature rise is relatively short, so that first cooling level needs to be started, and the cooling duration is extended.

In a specific implementation, in a cooling scenario, the target adjustment speed corresponding to the target difference between indoor and outdoor temperatures is duration for natural temperature rise by 1° C. and duration for cooling by 1° C. by the HVAC system for the current room based on the current indoor temperature value and the current outdoor temperature value; and

step 105 may include:

if an adjustment speed corresponding to the energy-saving level set by the user is a first speed, the first speed comprises upper limit duration t_nice for cooling by 1° C. and lower limit duration t_hold for natural temperature rise by 1° C.;

051: under a condition that the forgoing duration for cooling by 1° C. is greater than the forgoing upper limit duration t_nice, determining that the forgoing temperature adjustment level is a first cooling level; and

052: under a condition that the forgoing duration for cooling by 1° C. is less than the forgoing upper limit duration t_nice, determining that the forgoing temperature adjustment level is first cooling level.

Furthermore, optionally, the forgoing method further comprises:

053: under a condition that the forgoing duration for natural temperature rise by 1° C. is less than the forgoing lower limit duration t_hold, extending the temperature adjustment duration (cooling duration) in the forgoing target operating mode by preset duration; and

054: under a condition that the forgoing duration for natural temperature rise by 1° C. is greater than the forgoing lower limit duration t_hold, shortening the cooling duration in the forgoing target operating mode by preset duration.

It can be learned that, in this embodiment of the application, the temperature controller may choose, based on acquisition and analysis of a large amount of data, to start second cooling level in a scenario in which it is difficult to perform cooling, so as to increase cooling intensity (as described in step 051), and to extend the cooling duration (as described in step 053) in a scenario in which natural temperature rise is relatively quick, so as to prevent excessively quick natural temperature rise in a slight interference cooling manner, and improve comfort. In a scenario in which it is easy to perform cooling, only first cooling level may be started (as described in step 052) and the cooling duration may be shortened (as described in step 054) to reduce energy consumption and save energy. It can be understood that, in one or more embodiments of the present application, the heating efficiency of second cooling level is higher than the heating efficiency of first cooling level.

Similarly, referring to FIG. 4, the application further provides a schematic diagram of heating temperature changes. As shown in FIG. 4, duration required for heating by 1° C. is also closely related to the difference between indoor and outdoor temperatures: when the outdoor temperature value T1A is relatively close to the indoor temperature value T0, duration required for heating by 1° C. is relatively short, and duration required for natural temperature drop is relatively long, so that only first heating level may be started, and the heating duration is shortened; when the outdoor temperature value T1B is much greater than the indoor temperature value TO, duration required for heating by 1° C. is relatively long, and duration required for natural temperature drop is relatively short, so that first heating level needs to be started, and the heating duration is extended.

In a specific implementation, in a heating scenario, the target adjustment speed corresponding to the target difference between indoor and outdoor temperatures is duration for heating by one unit temperature by the HVAC system and duration for natural temperature drop by one unit temperature for the current room under the current indoor temperature value and the current outdoor temperature value; and

step 105 may include:

if an adjustment speed corresponding to the energy-saving level set by the user is a second speed, the second speed comprises upper limit duration t_nice for heating by 1° C. and lower limit duration t_hold for natural temperature drop by 1° C.;

055: under a condition that the forgoing duration for heating by 1° C. is greater than the forgoing upper limit duration t_nice, determining that the forgoing temperature adjustment level is a second heating level; and

056: under a condition that the forgoing duration for heating by 1° C. is less than the forgoing upper limit duration t_nice, determining that the forgoing temperature adjustment level is a first heating level.

Furthermore, optionally, the forgoing method further comprises:

057: under a condition that the forgoing duration for natural temperature drop by 1° C. is less than the forgoing lower limit duration t_hold, extending the temperature adjustment duration (heating duration) in the target operating mode by preset duration; and

058: under a condition that the forgoing duration for natural temperature drop by 1° C. is greater than the forgoing lower limit duration t_hold, shortening the heating duration in the target operating mode by preset duration.

It can be learned that, in this embodiment of the application, the temperature controller may choose, based on acquisition and analysis of a large amount of data, to start second heating level (as described in step 055) in a scenario in which it is difficult to perform heating, so as to increase heating intensity, and to extend the heating duration (as described in step 057) in a scenario in which natural temperature drop is relatively quick, so as to prevent excessively quick natural temperature drop in a slight interference heating manner, and improve comfort. In a scenario in which it is easy to perform heating, only first heating level cooling may be started (as described in step 056) and the heating duration may be shortened (as described in step 058) to reduce energy consumption and save energy. It can be understood that, in one or more embodiments of the present application, the heating efficiency of second heating level is higher than the heating efficiency of first heating level.

In the embodiment of the application, a target temperature value set by a user is obtained; a current energy-saving level is obtained, the current energy-saving level being used to limit an adjustment speed at which an HVAC system controls a temperature change; a target difference between indoor and outdoor temperatures is determined based on a current indoor temperature value and a current outdoor temperature value; a target adjustment speed corresponding to the target difference between indoor and outdoor temperatures is determined based on a corresponding relationship between an indoor and outdoor temperature difference of a current room and the adjustment speed at which the HVAC system controls a temperature change; a target operating mode is determined based on a relationship between the current energy-saving level and the target adjustment speed, the target operating mode including at least one of a temperature adjustment level and temperature adjustment duration; and the HVAC system is controlled to perform a temperature adjustment operation in the target operating mode. The temperature controller can continuously record data such as time for starting each device of the HVAC system, indoor temperature, and outdoor temperature, then obtain a temperature adjustment speed with house heat insulation properties based on enough data, calculate an adjustment speed of a temperature change in various scenarios with a difference between indoor and outdoor temperatures, that is, duration required for cooling or heating to a target temperature value, form a specific heating or cooling algorithm model based on comfort experience requirements and an energy-saving level selected by the user, and perform a reasonable control operation on the HVAC system by considering an influence of the difference between indoor and outdoor temperatures, so as to improve comfort and save energy.

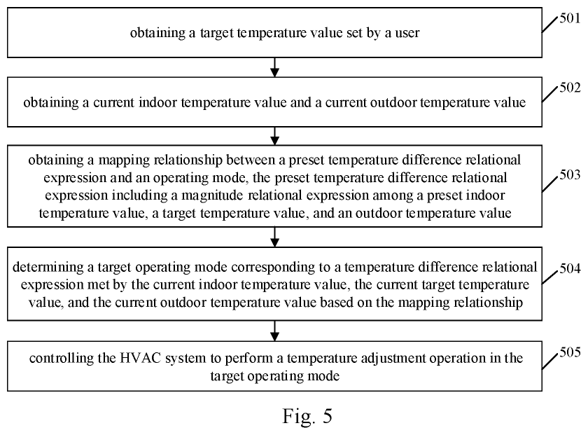

Further, FIG. 5 is a schematic flowchart of another temperature control method according to an embodiment of the application. As shown in FIG. 5, the method comprises:

501: obtaining a target temperature value set by a user.

502: obtaining a current indoor temperature value and a current outdoor temperature value.

For step 501, reference may be made to the specific description of step 101 in the embodiment shown in FIG. 1, and for the obtaining of the current indoor temperature value and the current outdoor temperature value, reference may be made to the specific description of step 102 in the embodiment shown in FIG. 1. Details are not described herein.

503: obtaining a mapping relationship between a preset temperature difference relational expression and an operating mode, the preset temperature difference relational expression including a magnitude relational expression among a preset indoor temperature value, a target temperature value, and an outdoor temperature value.

504: determining a target operating mode corresponding to a temperature difference relational expression met by the current indoor temperature value, the current target temperature value, and the current outdoor temperature value based on the mapping relationship.

505: controlling the HVAC system to perform a temperature adjustment operation in the target operating mode.

In the embodiment of the application, the mapping relationship between the temperature difference relational expression and the operating mode, that is, the magnitude relational expression among the various temperature values that different operating modes need to meet, may be preset as required, so that the corresponding operating mode may be determined based on the relationship met by current temperature values to perform temperature control. The target operating mode includes the temperature adjustment level.

In an implementation, to adjust and control the temperature, the preset temperature difference relational expression mainly takes the following two aspects into consideration: a difference between the indoor temperature value and the target temperature value set by the user, and a difference between the indoor temperature value and the outdoor temperature value, and the HAVC control is executed by determining the difference between the current temperature values. The heating or cooling intensity in different operating modes may be different, for example, different heating or cooling levels are set.

Optionally, the method further comprises: when the current outdoor temperature value is in a preset comfort temperature range, controlling the HVAC system to start periodic ventilation treatment. The comfort temperature range may be set as required, for example, 18-25° C.

In an optional implementation, step 104 may comprise: under a condition that a result of subtracting the target temperature value from the current indoor temperature value is greater than a first threshold, and a result of subtracting the current indoor temperature value from the current outdoor temperature value is greater than a second threshold, determining that the temperature adjustment level is a second cooling level; under a condition that a result of subtracting the target temperature value from the current indoor temperature value is greater than a third threshold, and a result of subtracting the current indoor temperature value from the current outdoor temperature value is less than or equal to the second threshold, determining that the temperature adjustment level is the second cooling level, the second threshold is greater than the third threshold, and the third threshold is greater than the first threshold; and under a condition that a result of subtracting the target temperature value from the current indoor temperature value is less than or equal to the third threshold, and a result of subtracting the current indoor temperature value from the current outdoor temperature value is less than or equal to the second threshold, determining that the temperature adjustment level is the first cooling level.

In another optional implementation, step 104 may comprise: under a condition that a result of subtracting the target temperature value from the current indoor temperature value is less than a fourth threshold, and a result of subtracting the current indoor temperature value from the current outdoor temperature value is greater than a fifth threshold, determining that the temperature adjustment level is a second heating level; under a condition that a result of subtracting the target temperature value from the current indoor temperature value is greater than a sixth threshold, and a result of subtracting the current indoor temperature value from the current outdoor temperature value is less than or equal to the fifth threshold, determining that the temperature adjustment level is the second heating level, the sixth threshold is less than the fourth threshold, and the fifth threshold is greater than the fourth threshold; and under a condition that a result of subtracting the target temperature value from the current indoor temperature value is less than the fourth threshold and greater than the sixth threshold, and a result of subtracting the current indoor temperature value from the current outdoor temperature value is less than or equal to the fifth threshold, determining that the temperature adjustment level is the first heating level.

In the embodiment of the application, each threshold may be set as required. For example, a comfort temperature range T3 is set, and the first threshold, second threshold and third threshold are 0° C., 5° C., and 3° C., respectively. After the temperature controller obtains a current indoor temperature value T0, a current outdoor temperature value T1, and a target temperature value Tset set by the user, determining an operating mode by using the mapping relationship may comprise:

if (T0−Tset=0° C.), prohibiting heating/cooling and starting periodic ventilation;

if (T0−Tset>0° C.) & (T1−T0>5° C.), starting second cooling level;

if (T0−Tset>3° C.) & (T1−T0<=5° C.), starting second cooling level;

if (T0−Tset<=3° C.) & (T1−T0<=5° C.), starting first cooling level;

the fourth threshold, fifth threshold, and sixth threshold are 0° C., 5° C., and 3° C., respectively:

if (T0−Tset<0° C.) & (T1−T0>5° C.), starting second heating level;

if (T0−Tset<−3° C.) & (T1−T0<=5° C.), starting second heating level; and

if (0° C.>T0−Tset>−3° C.) & (T1−T0<=5° C.), starting first cooling level.

By using the temperature control method, when the outdoor temperature is higher than the indoor temperature by 5° C. or above, second cooling level may be started to lower the indoor temperature as soon as possible to improve comfort; when the outdoor temperature is lower than the indoor temperature by 5° C., second heating level is started to increase the indoor temperature as soon as possible to improve comfort. In addition, if T1 is within the comfort temperature range T3 set by the user, heating/cooling may be stopped and periodic ventilation may be started to reduce energy consumption. The different temperature difference relationships and mapping relationships may be set as required, which is not limited in the embodiment of the application.

The control over starting and shutdown of each device of the HVAC system is usually based on a deviation relationship between a temperature value detected indoors and a set temperature. However, the indoor temperature change is affected by multiple factors, for example, an outdoor weather situation is an important factor. Specifically, for example, in the summer season, the current indoor temperature is 27° C., the user sets the target temperature to 25° C., and then the temperature controller may control devices of the HVAC system to perform first cooling level. However, the outdoor temperature is 35° C. at this time, due to a relatively large difference between indoor and outdoor temperatures, the indoor temperature decreases slowly, and user comfort may be greatly reduced if the second cooling level is not started. For another example, in autumn, the current indoor temperature is 23° C., the user has not changed the target temperature value of 25° C. set in summer, and then the temperature controller may still mechanically control the devices of the HVAC system to perform first heating level. However, at this time, the outdoor temperature has been lowered to 22° C., which is relatively comfortable. Instead of starting of the devices of the HVAC system for heating which wastes energy, only proper ventilation is needed.

The method according to the embodiment of the application can solve the problems in the aspects. In the embodiment of the application, a target temperature value set by a user is obtained; a current indoor temperature value and a current outdoor temperature value are obtained; a mapping relationship between a preset temperature difference relational expression and an operating mode is obtained, the preset temperature difference relational expression including a magnitude relational expression among a preset indoor temperature value, a target temperature value, and an outdoor temperature value; a target operating mode corresponding to a temperature difference relational expression met by the current indoor temperature value, the current target temperature value, and the current outdoor temperature value is determined based on the mapping relationship; and the HVAC system is controlled to perform a temperature adjustment operation in the target operating mode. An operation on the HVAC system is reasonably controlled by using a magnitude relationship between the current indoor temperature and outdoor temperature, and the set temperature, and an influence of the current outdoor temperature value is considered, so that the user's comfort experience can be improved, and energy consumption is effectively reduced.

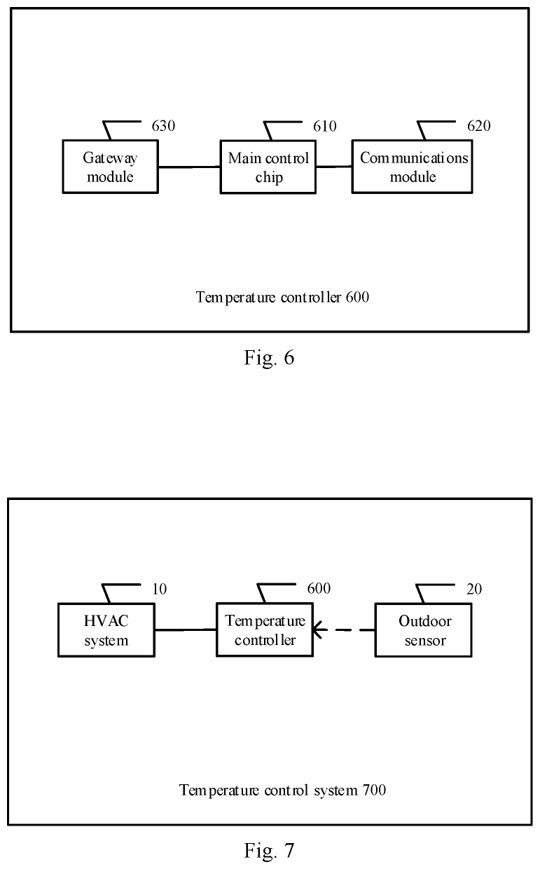

Based on the description of the embodiment of the temperature control method, an embodiment of the application further discloses a temperature controller. Referring to FIG. 6, the temperature controller 600 comprises a main control chip 610 and a memory. A computer program is stored in the memory, and when the computer program is executed by a processor, the processor is enabled to perform steps of the method embodiment.

Optionally, the temperature controller further comprises a communication module 620 and a gateway module 630;

the temperature controller 600 is connected to an HVAC system through a control line, and the HVAC system is configured to perform cooling, heating or ventilation treatment indoors;

the gateway module 630 is configured to obtain the outdoor temperature value acquired by an outdoor sensor module;

the temperature controller 620 is configured to be connected to the Internet, and obtain the current outdoor temperature value acquired by the outdoor sensor module and uploaded to the Internet; and

the main control chip 610 is configured to perform each step of the method in the embodiment of FIG. 1 or FIG. 5, which will not be described in detail herein. In the embodiment of the application, the temperature controller 600 reasonably controls the operation on the HVAC system by using the magnitude relationship between the current indoor temperature and outdoor temperature, and the set temperature, and an influence of the current outdoor temperature value is considered, so that the user's comfort experience can be improved. The adjustment speed of the HVAC system is controlled by using the energy-saving level, thereby effectively reducing energy consumption.

In another embodiment of the application, a temperature controller with another structure is provided. The temperature controller comprises:

an obtaining module, configured to obtain a target temperature value set by a user;

the obtaining module, further configured to obtain a current energy-saving level, the current energy-saving level being used to limit an adjustment speed at which the HVAC system controls a temperature change; and

a processing module, configured to determine a target difference between indoor and outdoor temperatures based on a current indoor temperature value and a current outdoor temperature value;

the processing module, further configured to determine a target adjustment speed corresponding to the target difference between indoor and outdoor temperatures based on a corresponding relationship between an indoor and outdoor temperature difference of a current room and the adjustment speed at which the HVAC system controls a temperature change;

the processing module, further configured to determine a target operating mode based on a relationship between the current energy-saving level and the target adjustment speed, the target operating mode including at least one of a temperature adjustment level and temperature adjustment duration; and

the processing module, further configured to control the HVAC system to perform a temperature adjustment operation in the target operating mode.

The temperature controller is configured to perform each step of the method in the embodiment of FIG. 1 or FIG. 5, which will not be described in detail herein. In the embodiment of the application, the temperature controller reasonably controls the operation on the HVAC system by using the magnitude relationship between the current indoor temperature and outdoor temperature, and the set temperature, and an influence of the current outdoor temperature value is considered, so that the user's comfort experience can be improved. The adjustment speed of the HVAC system is controlled by using the energy-saving level, thereby effectively reducing energy consumption.

In an optional solution, in a cooling scenario, the target adjustment speed corresponding to the target difference between indoor and outdoor temperatures is duration for natural temperature rise by one unit temperature and duration for cooling by one unit temperature by the HVAC system for the current room based on the target difference between indoor and outdoor temperatures; and

in the aspect of determining a target operating mode based on a relationship between the current energy-saving level and the target adjustment speed, the processing module is specifically configured to:

based on that the adjustment speed corresponding to the current energy-saving level is a first speed, enable the first speed to comprise upper limit duration for cooling by one unit temperature and lower limit duration for natural temperature rise by one unit temperature, and under a condition that the duration for cooling by one unit temperature is greater than the upper limit duration, determine that the temperature adjustment level is a second cooling level; and

under a condition that the duration for cooling by one unit temperature is less than the upper limit duration, determine that the temperature adjustment level is a first cooling level.

Optionally, the processing module is further configured to:

under a condition that the duration for natural temperature rise by one unit temperature is less than the lower limit duration, extend the temperature adjustment duration in the target operating mode by preset duration; and

under a condition that the duration for natural temperature rise by one unit temperature is greater than the lower limit duration, shorten the temperature adjustment duration in the target operating mode by preset duration.

In an optional solution, in a heating scenario, the target adjustment speed corresponding to the target difference between indoor and outdoor temperatures is duration for heating by one unit temperature by the HVAC system and duration for natural temperature drop by one unit temperature for the current room under the target difference between indoor and outdoor temperatures; and

in the aspect of determining a target operating mode based on a relationship between the current energy-saving level and the target adjustment speed, the processing module is specifically configured to:

based on that the adjustment speed corresponding to the current energy-saving level is a second speed, enable the second speed to comprise upper limit duration for heating by one unit temperature and lower limit duration for natural temperature drop by one unit temperature, and under a condition that the duration for heating by one unit temperature is greater than the upper limit duration, determine that the temperature adjustment level is a second heating level; and

under a condition that the duration for heating by one unit temperature is less than the upper limit duration, determine that the temperature adjustment level is a first heating level.

Optionally, the processing module is further configured to:

under a condition that the duration for natural temperature drop by one unit temperature is less than the lower limit duration, extend the temperature adjustment duration in the target operating mode by preset duration; and

under a condition that the duration for natural temperature drop by one unit temperature is greater than the lower limit duration, shorten the temperature adjustment duration in the target operating mode by preset duration.

In an optional solution, the obtaining module is further configured to obtain a mapping relationship between a preset temperature difference relational expression and an operating mode, the preset temperature difference relational expression including a magnitude relational expression among a preset indoor temperature value, a target temperature value, and an outdoor temperature value; and

the processing module is further configured to determine a target operating mode corresponding to a temperature difference relational expression met by the current indoor temperature value, the current target temperature value, and the current outdoor temperature value based on the mapping relationship.

In an optional solution, in the aspect of determining a target operating mode corresponding to a temperature difference relational expression met by the current indoor temperature value, the current target temperature value, and the current outdoor temperature value based on the mapping relationship, the processing module is specifically configured to:

under a condition that a result of subtracting the target temperature value from the current indoor temperature value is greater than a first threshold, and a result of subtracting the current indoor temperature value from the current outdoor temperature value is greater than a second threshold, determine that the temperature adjustment level is a second cooling level; under a condition that a result of subtracting the target temperature value from the current indoor temperature value is greater than a third threshold, and a result of subtracting the current indoor temperature value from the current outdoor temperature value is less than or equal to the second threshold, determine that the temperature adjustment level is the second cooling level, the second threshold is greater than the third threshold, and the third threshold is greater than the first threshold; and under a condition that a result of subtracting the target temperature value from the current indoor temperature value is less than or equal to the third threshold, and a result of subtracting the current indoor temperature value from the current outdoor temperature value is less than or equal to the second threshold, determine that the temperature adjustment level is the first cooling level;

or,

under a condition that a result of subtracting the target temperature value from the current indoor temperature value is less than a fourth threshold, and a result of subtracting the current indoor temperature value from the current outdoor temperature value is greater than a fifth threshold, determine that the temperature adjustment level is a second heating level; under a condition that a result of subtracting the target temperature value from the current indoor temperature value is greater than a sixth threshold, and a result of subtracting the current indoor temperature value from the current outdoor temperature value is less than or equal to the fifth threshold, determine that the temperature adjustment level is the second heating level, the sixth threshold is less than the fourth threshold, and the fifth threshold is greater than the fourth threshold; and under a condition that a result of subtracting the target temperature value from the current indoor temperature value is less than the fourth threshold and greater than the sixth threshold, and a result of subtracting the current indoor temperature value from the current outdoor temperature value is less than or equal to the fifth threshold, determine that the temperature adjustment level is the first heating level.

In the embodiment of the application, the temperature controller reasonably controls the operation on the HVAC system by using the magnitude relationship between the current indoor temperature and outdoor temperature, and the set temperature, and an influence of the current outdoor temperature value is considered, so that the user's comfort experience can be improved. The adjustment speed of the HVAC system is controlled by using the energy-saving level, thereby effectively reducing energy consumption.

Based on the description of the embodiment of the temperature control method, an embodiment of the application further discloses a temperature control system. FIG. 7 is a schematic structural diagram of a temperature control system according to an embodiment of the application. The temperature control system 700 comprises an HVAC system 10, an outdoor sensor 20 and the temperature controller 600 as shown in FIG. 6;

the temperature controller 600 is connected to the HVAC system 10 through a control line;

the outdoor sensor 20 is configured to acquire an outdoor temperature value and provide the outdoor temperature value to the temperature controller 600; and

the temperature controller 600 is configured to perform the temperature control method in the embodiment of the application. In an embodiment, each step of the method in the embodiment shown in FIG. 1 or FIG. 3 may be performed by the temperature controller 600, which will not be described in detail herein.

An embodiment of the application further provides a computer storage medium (memory), and the computer storage medium is a memory device in an electronic device (the temperature controller), and is configured to store a program and data. It may be understood that the computer storage medium herein may not only include a built-in storage medium in the electronic device, but also include an extended storage medium supported by the electronic device. The computer storage medium provides a storage space in which an operating system of the electronic device is stored. In addition, one or more instructions suitable for being loaded and executed by a processor 1001 are further stored in the storage space, and these instructions may be one or more computer programs (including program code). It should be noted that the computer storage medium herein may be a high-speed RAM or a non-volatile memory, such as at least one disk memory. Optionally, the computer storage medium may alternatively be at least one computer storage medium located remotely from the processor.

In an embodiment, one or more instructions stored in a computer storage medium may be loaded and executed by a processor to implement the corresponding steps in the embodiments. During specific implementation, the one or more instructions in the computer storage medium may be loaded by the processor and perform each step and the like in the method shown in FIG. 1 and/or FIG. 3, which will not be described in detail herein.

A person skilled in the art can clearly understand that for ease and conciseness of description, for the specific operating processes of the apparatuses and modules described above, reference may be made to the corresponding processes in the method embodiments. Details are not repeated herein.

In several embodiments according to the application, it should be understood that the disclosed system, apparatus and method may be implemented in other ways. For example, the division of the modules is merely logical function division and may be other division during actual implementation. For example, a plurality of modules or components may be combined or integrated into another system, or some features may be ignored or not performed. The mutual coupling or direct coupling or communication connection shown or discussed may be indirect coupling or communication connection through some interfaces, apparatuses or modules, and may be in electrical, mechanical or other forms.

Modules described as separate components may or may not be physically separated. Components displayed as modules may or may not be physical modules, that is, the components may be located in one place, or may be distributed to a plurality of network modules. Some or all of the modules may be selected according to actual needs to implement the objective of the solution of this embodiment.

The embodiment may be implemented in whole or in part by using software, hardware, firmware or any combination thereof. When the embodiment is implemented by using software, the embodiment may be implemented in whole or in part in the form of a computer program product. The computer program product includes one or more computer instructions. When the computer program instructions are loaded and executed on a computer, processes or functions according to the embodiment of the application are generated in whole or in part. The computer may be a general-purpose computer, a special-purpose computer, a computer network, or another programmable apparatus. The computer instructions may be stored in a computer-readable storage medium or transmitted through the computer-readable storage medium. The computer instructions may be transmitted from one website, computer, server or data center to another website, computer, server or data center in a wired (such as a coaxial cable, an optical fiber, or a digital subscriber line (DSL)) or wireless (such as infrared, Wi-Fi, or microwave) manner. The computer-readable storage medium may be any available medium that a computer can access or a data storage device including one or more available media integrated servers, data centers and the like. The available medium may be a read-only memory (ROM), or a random access memory (RAM), or a magnetic medium, such as a floppy disk, a hard disk, a magnetic tape, a magnetic disk, or an optical medium, such as a digital versatile disc (DVD), or a semiconductor medium, such as a solid state disk (SSD).

What is claimed is:

1. A temperature control method applied to a temperature controller, comprising:
obtaining a target temperature value set by a user;
obtaining a current energy-saving level, said current energy-saving level being used to limit an adjustment speed at which a heating, ventilation, air-conditioning and cooling (HVAC) system controls a temperature change;
determining a target difference between indoor and outdoor temperatures based on a current indoor temperature value and a current outdoor temperature value;
determining a target adjustment speed corresponding to said target difference between indoor and outdoor temperatures based on a corresponding relationship between an indoor and outdoor temperature difference of a current room and said adjustment speed at which said HVAC system controls a temperature change;
determining a target operating mode based on a relationship between said current energy-saving level and said target adjustment speed, said target operating mode comprising at least one of a temperature adjustment level and temperature adjustment duration; and
controlling said HVAC system to perform a temperature adjustment operation in said target operating mode.

2. The method, as recited in claim 1, wherein in a cooling scenario, said target adjustment speed corresponding to said target difference between indoor and outdoor temperatures comprises duration for natural temperature rise by one unit temperature and duration for cooling by one unit temperature by said HVAC system for said current room under said target difference between indoor and outdoor temperatures; and
the determining a target operating mode based on a relationship between said current energy-saving level and said target adjustment speed comprises:
based on that an adjustment speed corresponding to said current energy-saving level is a first speed, said first speed comprising upper limit duration for cooling by one unit temperature and lower limit duration for natural temperature rise by one unit temperature; and
under a condition that said duration for cooling by one unit temperature is greater than said upper limit duration, determining that said temperature adjustment level is a second cooling level; and
under a condition that said duration for cooling by one unit temperature is less than said upper limit duration, determining that said temperature adjustment level is a first cooling level.

3. The method, as recited in claim 2, further comprising:
under a condition that said duration for natural temperature rise by one unit temperature is less than said lower limit duration, extending said temperature adjustment duration in said target operating mode by a first preset duration; and
under a condition that said duration for natural temperature rise by one unit temperature is greater than said lower limit duration, shortening said temperature adjustment duration in said target operating mode by a second preset duration.

4. The method, as recited in claim 1, wherein in a heating scenario, said target adjustment speed corresponding to said target difference between indoor and outdoor temperatures comprises duration for heating by one unit temperature by said HVAC system and duration for natural temperature drop by one unit temperature for said current room under said target difference between indoor and outdoor temperatures; and
said determining said target operating mode based on said relationship between said current energy-saving level and said target adjustment speed comprises:
based on that said adjustment speed corresponding to said current energy-saving level is a second speed, said second speed comprising upper limit duration for heating by one unit temperature and lower limit duration for natural temperature drop by one unit temperature; and
under a condition that said duration for heating by one unit temperature is greater than said upper limit duration, determining that said temperature adjustment level is a second heating level; and
under a condition that said duration for heating by one unit temperature is less than said upper limit duration, determining that said temperature adjustment level is a first heating level.

5. The method, as recited in claim 4, further comprising:
under a condition that said duration for natural temperature drop by one unit temperature is less than said lower limit duration, extending said temperature adjustment duration in said target operating mode by a third preset duration; and
under a condition that said duration for natural temperature drop by one unit temperature is greater than said lower limit duration, shortening said temperature adjustment duration in said target operating mode by a fourth preset duration.

6. The method, as recited in claim 1, further comprising:
obtaining a mapping relationship between a preset temperature difference relational expression and an operating mode, said preset temperature difference relational expression comprising a magnitude relational expression among a preset indoor temperature value, a target temperature value, and an outdoor temperature value; and
determining a target operating mode corresponding to a temperature difference relational expression met by said current indoor temperature value, said current target temperature value, and said current outdoor temperature value based on said mapping relationship.

7. The method, as recited in claim 6, wherein said determining said target operating mode corresponding to said temperature difference relational expression met by said current indoor temperature value, said current target temperature value, and said current outdoor temperature value based on said mapping relationship comprises:
under a condition that a result of subtracting said target temperature value from said current indoor temperature value is greater than a first threshold, and a result of subtracting said current indoor temperature value from said current outdoor temperature value is greater than a second threshold, determining that said temperature adjustment level is a second cooling level; under a condition that a result of subtracting said target temperature value from said current indoor temperature value is greater than a third threshold, and a result of subtracting said current indoor temperature value from said current outdoor temperature value is less than or equal to said second threshold, determining that said temperature adjustment level is said second cooling level, said second threshold is greater than said third threshold, and said third threshold is greater than said first threshold; and under a condition that a result of subtracting said target temperature value from said current indoor temperature value is less than or equal to said third threshold, and a result of subtracting said current indoor temperature value from said current outdoor temperature value is less than or equal to said second threshold, determining that said temperature adjustment level is a first cooling level;
or,
under a condition that a result of subtracting said target temperature value from said current indoor temperature value is less than a fourth threshold, and a result of subtracting said current indoor temperature value from said current outdoor temperature value is greater than a fifth threshold, determining that said temperature adjustment level is a second heating level; under a condition that a result of subtracting said target temperature value from said current indoor temperature value is greater than a sixth threshold, and a result of subtracting said current indoor temperature value from said current outdoor temperature value is less than or equal to said fifth threshold, determining that said temperature adjustment level is said a second heating level, said sixth threshold is less than said fourth threshold, and said fifth threshold is greater than said fourth threshold; and under a condition that a result of subtracting said target temperature value from said current indoor temperature value is less than said fourth threshold and greater than said sixth threshold, and a result of subtracting said current indoor temperature value from said current outdoor temperature value is less than or equal to said fifth threshold, determining that said temperature adjustment level is a first heating level.

8. A temperature controller, comprising a main control chip and a memory, wherein
a computer program is stored in said memory, and when said computer program is executed by a processor, said processor is enabled to perform:
obtaining a target temperature value set by a user;
obtaining a current energy-saving level, said current energy-saving level being used to limit an adjustment speed at which a heating, ventilation, air-conditioning and cooling (HVAC) system controls a temperature change;
determining a target difference between indoor and outdoor temperatures based on a current indoor temperature value and a current outdoor temperature value;
determining a target adjustment speed corresponding to said target difference between indoor and outdoor temperatures based on a corresponding relationship between an indoor and outdoor temperature difference of a current room and said adjustment speed at which said HVAC system controls a temperature change;
determining a target operating mode based on a relationship between said current energy-saving level and said target adjustment speed, said target operating mode comprising at least one of a temperature adjustment level and temperature adjustment duration; and
controlling said HVAC system to perform a temperature adjustment operation in said target operating mode.

9. The temperature controller, as recited in claim 8, wherein in a cooling scenario, said target adjustment speed corresponding to said target difference between indoor and outdoor temperatures comprises duration for natural temperature rise by one unit temperature and duration for cooling by one unit temperature by said HVAC system for said current room under said target difference between indoor and outdoor temperatures; and
the determining a target operating mode based on a relationship between said current energy-saving level and said target adjustment speed comprises:
based on that an adjustment speed corresponding to said current energy-saving level is a first speed, said first speed comprising upper limit duration for cooling by one unit temperature and lower limit duration for natural temperature rise by one unit temperature; and
under a condition that said duration for cooling by one unit temperature is greater than said upper limit duration, determining that said temperature adjustment level is a second cooling level; and
under a condition that said duration for cooling by one unit temperature is less than said upper limit duration, determining that said temperature adjustment level is a first cooling level.

10. The temperature controller, as recited in claim 9, further comprising:
under a condition that said duration for natural temperature rise by one unit temperature is less than said lower limit duration, extending said temperature adjustment duration in said target operating mode by a first preset duration; and
under a condition that said duration for natural temperature rise by one unit temperature is greater than said lower limit duration, shortening said temperature adjustment duration in said target operating mode by a second preset duration.

11. The temperature controller, as recited in claim 8, wherein in a heating scenario, said target adjustment speed corresponding to said target difference between indoor and outdoor temperatures comprises duration for heating by one unit temperature by said HVAC system and duration for natural temperature drop by one unit temperature for said current room under said target difference between indoor and outdoor temperatures; and
said determining said target operating mode based on said relationship between said current energy-saving level and said target adjustment speed comprises:
based on that said adjustment speed corresponding to said current energy-saving level is a second speed, said second speed comprising upper limit duration for heating by one unit temperature and lower limit duration for natural temperature drop by one unit temperature; and
under a condition that said duration for heating by one unit temperature is greater than said upper limit duration, determining that said temperature adjustment level is a second heating level; and
under a condition that said duration for heating by one unit temperature is less than said upper limit duration, determining that said temperature adjustment level is a first heating level.

12. The temperature controller, as recited in claim 11, further comprising:
under a condition that said duration for natural temperature drop by one unit temperature is less than said lower limit duration, extending said temperature adjustment duration in said target operating mode by third preset duration; and
under a condition that said duration for natural temperature drop by one unit temperature is greater than said lower limit duration, shortening said temperature adjustment duration in said target operating mode by a fourth preset duration.

13. The temperature controller, as recited in claim 8, further comprising:
obtaining a mapping relationship between a preset temperature difference relational expression and an operating mode, said preset temperature difference relational expression comprising a magnitude relational expression among a preset indoor temperature value, a target temperature value, and an outdoor temperature value; and
determining a target operating mode corresponding to a temperature difference relational expression met by said current indoor temperature value, said current target temperature value, and said current outdoor temperature value based on said mapping relationship.

14. The temperature controller, as recited in claim 13, wherein said determining said target operating mode corresponding to said temperature difference relational expression met by said current indoor temperature value, said current target temperature value, and said current outdoor temperature value based on said mapping relationship comprises:
under a condition that a result of subtracting said target temperature value from said current indoor temperature value is greater than a first threshold, and a result of subtracting said current indoor temperature value from said current outdoor temperature value is greater than a second threshold, determining that said temperature adjustment level is a second cooling level; under a condition that a result of subtracting said target temperature value from said current indoor temperature value is greater than a third threshold, and a result of subtracting said current indoor temperature value from said current outdoor temperature value is less than or equal to said second threshold, determining that said temperature adjustment level is said second cooling level, said second threshold is greater than said third threshold, and said third threshold is greater than said first threshold; and under a condition that a result of subtracting said target temperature value from said current indoor temperature value is less than or equal to said third threshold, and a result of subtracting said current indoor temperature value from said current outdoor temperature value is less than or equal to said second threshold, determining that said temperature adjustment level is a first cooling level;
or,
under a condition that a result of subtracting said target temperature value from said current indoor temperature value is less than a fourth threshold, and a result of subtracting said current indoor temperature value from said current outdoor temperature value is greater than a fifth threshold, determining that said temperature adjustment level is a second heating level; under a condition that a result of subtracting said target temperature value from said current indoor temperature value is greater than a sixth threshold, and a result of subtracting said current indoor temperature value from said current outdoor temperature value is less than or equal to said fifth threshold, determining that said temperature adjustment level is said second heating level, said sixth threshold is less than said fourth threshold, and said fifth threshold is greater than said fourth threshold; and under a condition that a result of subtracting said target temperature value from said current indoor temperature value is less than said fourth threshold and greater than said sixth threshold, and a result of subtracting said current indoor temperature value from said current outdoor temperature value is less than or equal to said fifth threshold, determining that said temperature adjustment level is a first heating level.

15. A temperature control system, comprising an HVAC system, an outdoor sensor, and a temperature controller, wherein
said temperature controller is connected to said HVAC system through a control line;
said outdoor sensor is configured to acquire an outdoor temperature value and provide said outdoor temperature value to said temperature controller; and
said temperature controller is configured to perform:
obtaining a target temperature value set by a user;
obtaining a current energy-saving level, said current energy-saving level being used to limit an adjustment speed at which a heating, ventilation, air-conditioning and cooling (HVAC) system controls a temperature change;
determining a target difference between indoor and outdoor temperatures based on a current indoor temperature value and a current outdoor temperature value;
determining a target adjustment speed corresponding to said target difference between indoor and outdoor temperatures based on a corresponding relationship between an indoor and outdoor temperature difference of a current room and said adjustment speed at which said HVAC system controls a temperature change;
determining a target operating mode based on a relationship between said current energy-saving level and said target adjustment speed, said target operating mode comprising at least one of a temperature adjustment level and temperature adjustment duration; and
controlling said HVAC system to perform a temperature adjustment operation in said target operating mode.

16. The temperature control system, as recited in claim 15, wherein in a cooling scenario, said target adjustment speed corresponding to said target difference between indoor and outdoor temperatures comprises duration for natural temperature rise by one unit temperature and duration for cooling by one unit temperature by said HVAC system for said current room under said target difference between indoor and outdoor temperatures; and
the determining a target operating mode based on a relationship between said current energy-saving level and said target adjustment speed comprises:
based on that an adjustment speed corresponding to said current energy-saving level is a first speed, said first speed comprising upper limit duration for cooling by one unit temperature and lower limit duration for natural temperature rise by one unit temperature; and
under a condition that said duration for cooling by one unit temperature is greater than said upper limit duration, determining that said temperature adjustment level is a second cooling level; and
under a condition that said duration for cooling by one unit temperature is less than said upper limit duration, determining that said temperature adjustment level is a first cooling level.

17. The temperature control system, as recited in claim 15, wherein in a heating scenario, said target adjustment speed corresponding to said target difference between indoor and outdoor temperatures comprises duration for heating by one unit temperature by said HVAC system and duration for natural temperature drop by one unit temperature for said current room under said target difference between indoor and outdoor temperatures; and
said determining said target operating mode based on said relationship between said current energy-saving level and said target adjustment speed comprises:
based on that said adjustment speed corresponding to said current energy-saving level is a second speed, said second speed comprising upper limit duration for heating by one unit temperature and lower limit duration for natural temperature drop by one unit temperature; and
under a condition that said duration for heating by one unit temperature is greater than said upper limit duration, determining that said temperature adjustment level is a second heating level; and
under a condition that said duration for heating by one unit temperature is less than said upper limit duration, determining that said temperature adjustment level is a first heating level.

18. The temperature control system, as recited in claim 15, further comprising:
obtaining a mapping relationship between a preset temperature difference relational expression and an operating mode, said preset temperature difference relational expression comprising a magnitude relational expression among a preset indoor temperature value, a target temperature value, and an outdoor temperature value; and
determining a target operating mode corresponding to a temperature difference relational expression met by said current indoor temperature value, said current target temperature value, and said current outdoor temperature value based on said mapping relationship.

19. The temperature control system, as recited in claim 18, wherein said determining said target operating mode corresponding to said temperature difference relational expression met by said current indoor temperature value, said current target temperature value, and said current outdoor temperature value based on said mapping relationship comprises:
under a condition that a result of subtracting said target temperature value from said current indoor temperature value is greater than a first threshold, and a result of subtracting said current indoor temperature value from said current outdoor temperature value is greater than a second threshold, determining that said temperature adjustment level is a second cooling level; under a condition that a result of subtracting said target temperature value from said current indoor temperature value is greater than a third threshold, and a result of subtracting said current indoor temperature value from said current outdoor temperature value is less than or equal to said second threshold, determining that said temperature adjustment level is said second cooling level, said second threshold is greater than said third threshold, and said third threshold is greater than said first threshold; and under a condition that a result of subtracting said target temperature value from said current indoor temperature value is less than or equal to said third threshold, and a result of subtracting said current indoor temperature value from said current outdoor temperature value is less than or equal to said second threshold, determining that said temperature adjustment level is a first cooling level;
or,
under a condition that a result of subtracting said target temperature value from said current indoor temperature value is less than a fourth threshold, and a result of subtracting said current indoor temperature value from said current outdoor temperature value is greater than a fifth threshold, determining that said temperature adjustment level is a second heating level; under a condition that a result of subtracting said target temperature value from said current indoor temperature value is greater than a sixth threshold, and a result of subtracting said current indoor temperature value from said current outdoor temperature value is less than or equal to said fifth threshold, determining that said temperature adjustment level is said a second heating level, said sixth threshold is less than said fourth threshold, and said fifth threshold is greater than said fourth threshold; and under a condition that a result of subtracting said target temperature value from said current indoor temperature value is less than said fourth threshold and greater than said sixth threshold, and a result of subtracting said current indoor temperature value from said current outdoor temperature value is less than or equal to said fifth threshold, determining that said temperature adjustment level is a first heating level.
